(19) United States
(12) Patent Application Publication
(10) Pub. No.: US 2022/0404605 A1
(43) Pub. Date: Dec. 22, 2022

(54) FLEXIBLE STOP FOR OPTICAL APPARATUSES AND AN OPTICAL APPARATUS HAVING SAME

(71) Applicant: Schmidt & Bender GmbH & Co. KG, Biebertal (DE)

(72) Inventors: Michael HOLZMANN, Butzbach (DE); Jörg HENNEMANN, Biebertal (DE); Jonas HÖLLER, Lich (DE); Antonia OTTE, Pohlheim (DE)

(21) Appl. No.: 17/838,513

(22) Filed: Jun. 13, 2022

(30) Foreign Application Priority Data
Jun. 21, 2021 (DE) 10 2021 115 995.4

(51) Int. Cl. G02B 23/16; F41G 1/38; F41A 35/02

(52) U.S. Cl. CPC G02B 23/16; F41G 1/38; F41A 35/02

(57) ABSTRACT

An optical apparatus flexible stop has a flexible surface element, which is flat/planar in a first state and rolled or wound into a hollow roll in a second state. Two tensioning cords guide around the hollow roll to hold the hollow roll shape. An optical apparatus is provided with a tubular body containing an optical unit and having a first open tube end, an attachment device having a device housing, wherein an optical through passage of the device housing is arranged in front of the open tube end, and the flexible stop. The flexible stop is rolled or wound around the open tube end of the tubular body and the optical through passage of the device housing, held in the shape of a tube with the tensioning cords, thus forming an optical tunnel between the open tube end and the optical through passage.

The invention relates to a flexible stop as claimed in claim 1 and to an optical apparatus having same as claimed in claim 15.

Various optical stops with which the incidence of light into optical apparatuses can be reduced or stopped or, the other way round, which prevent light from leaving, are known from the prior art. Attachment devices that either digitize or condition the optical radiation or inject information, data or graphics into the beam path are increasingly being used in particular in telescopic sights. In this way it is possible for a second person, for example, to follow along on a screen with respect to what the shooter perceives through the telescopic sight, to make optical radiation visible in the first place using night vision technology or to display target marks and shooting information, such as wind, shooting distance and projectile data and the setting of the adjustment wheels and turrets of the telescopic sight.

A problem here is that the telescopic sight and the attachment device have no standardized interface. For example, there are huge bandwidths of diameters of telescopic sight housings, in particular in the area of its objective and eyepiece. On the other hand, the attachment devices are often produced by other suppliers than the telescopic sights, meaning that coordination becomes difficult. Due to the lack of an interface, light can penetrate the intermediate space between the telescopic sight and the attachment device, resulting in a loss of image quality all the way to a complete inability to recognize anything. On the other hand, light, in particular of the attachment device, can also emerge from the interface. This scares up sensitive animals, and the shooter may be spotted.

For this reason, stops are used that are made from rubber using expensive molded parts which form a sealing ring between the telescopic sight and the attachment device. Due to the small quantities for the respective telescopic sight-attachment device interfaces, the costs of the molded parts are high because of the expensive toolmaking and expensive set-up times.

It is therefore an object of the invention to provide a stop that is suitable for a large number of different interfaces between the telescopic sight and the attachment device and is cost-effective to produce.

The main features of the invention are specified in claims 1 and 15. Configurations form the subject matter of claims 2 to 14 and 16 to 18.

The invention relates to a flexible stop for optical apparatuses, having a flexible surface element which, in a first state, has a flat and planar shape and, in a second state, is rolled or wound into a hollow roll, having at least two tensioning cords which, in the second state, are guided around the hollow roll and hold the hollow roll in the rolled or wound shape.

Using the flexible surface element, the stop can be adapted for example to different objective diameters of telescopic sights and diameters of the connecting piece of an attachment device. The roll can be rolled or wound cylindrically or in the shape of a cone frustum. The ends of the roll thus readily adapt to the diameter of the telescopic sight and the attachment device. Using the tensioning cords, the stop can then be mounted on the telescopic sight and attachment device. This prevents the situation in which disturbing light reaches the area between the telescopic sight and the attachment device. Likewise, for example, no light from the display of the attachment device can emerge from between the latter and the telescopic sight either. The stop preferably consists of a material which is not detectable thermally, in particular in the infrared range from 780 nm to 1 mm. For this purpose, said stop should have a low heat storage capacity. Also suitable herefor are for example particular types of fabric mixtures.

According to an optional configuration, the tensioning cords in the second state are in each case guided through at least two cord tunnels which are arranged or formed on the surface element. In this way, the tensioning cords cannot slide out of place and correspondingly reliably hold the tension and hold the roll in shape.

Advantageously, the cord tunnels can be formed by sewn-on tabs or straps. This is easy to produce, robust, and allows simple threading of the tensioning cords. In addition, the tensioning cords are effectively prevented from sliding out of place on the surface element.

In one preferred configuration, the tensioning cords are secured in the second state with in each case one tensioning element or a clamp. This allows simple tensioning and also re-tensioning, if needed. Ends of the tensioning cords can optionally be knotted together to ensure that they do not unintentionally slide through the tensioning element or the clamp. Optional end sleeves on the tensioning cords, e.g. made from tube material, allow simple threading and prevent fraying.

In a special variant, tension elements or the clamps are fixed in each case at the flexible surface element, preferably at its periphery. In this way, the tensioning cords have at least one defined position, the tension elements or the clamps will not be lost, and handling is easier.

In one advantageous configuration, provision is made for at least one of the tensioning cords to be guided around the hollow roll in the region of a first end of the hollow roll and for a further one of the tensioning cords to be guided around the hollow roll in the region of a second end of the hollow roll. In this way, the respective tensioning cord can be tensioned fixedly on the roll because the roll is then supported in the mounting state from the inside by a tubular body or an attachment device. The latter are thus tightly enclosed, and light can no longer reach the intermediate space between, for example, the telescopic sight and the attachment device.

It is preferably proposed that the tensioning cords are rubber cords. The latter exert a continuous tensioning force and reliably hold the stop in the desired position.

Specifically, the flexible surface element can have at least one first layer made of a textile fabric. Fabric is robust, can be configured to be non-glossy and is difficult to detect thermally,

Optionally, the flexible surface element can have at least one second layer made of a textile fabric. A second layer reduces the transmittance and it is easier to functionally design the upper and lower sides of the stop, for example with different camouflage patterns and surface structures.

Further optionally, the flexible surface element can have at least one stabilization layer made of a bendable plate material or film material. This gives the stop a greater stiffness and prevents, for example, other parts of the stop from projecting into the interspace between a tubular body and an attachment device, for example textile fabric that sags or has been “lashed together.” The stabilization layer can be a flexible plastics element.

Optionally, the stabilization layer is arranged between the first and the second layer. In this way, the stabilization layer can be designed in view of its stiffness and opacity, without taking into account color and gloss, for example. The stabilization layer is preferably sewn in between the first and the second layer. With further preference, there is also a connection between the stabilization layer and the first and/or the second layer by way of the surface. In this way, especially the inner layer cannot sag away from the stabilization layer. Sewing, lamination or adhesive bonding are suitable to form the connection. This also prevents the first and the second layer from migrating around the stabilization layer.

Provision is furthermore made advantageously for an upper side and a lower side of the flexible surface element to be configured in the same way so that it is possible to use the upper side or the lower side as the outer side of the hollow roll. It is hereby possible by turning over, for example, to perform a color change of the stop. Preferably, cord tunnels, which can be formed in particular by sewn-on tabs or straps, are then provided on the upper side and lower side.

Specifically, the upper side and the lower side have different camouflage patterns and/or surface structures. The stop can thus be used on both sides, for example during the day and at night, or during the summer and in winter. By way of example, a green-brown camouflage pattern can be on one side, and a white/gray/black snow camouflage pattern can be on the other side.

The flexible surface element is preferably opaque. In this way, entry and exit of light are effectively prevented.

The invention additionally relates to an optical apparatus having a tubular body containing an optical unit and having a first open tube end, an attachment device with a device housing, wherein an optical through passage of the device housing is arranged in front of the open tube, and a flexible stop in the second state, as has been and will be described. The flexible stop is here rolled or wound around the open tube end of the tubular body and the optical through passage of the device housing, held in the shape of a tube with the tensioning cords, and thus forms an optical tunnel between the open tube end of the tubular body and the optical through passage of the device housing. The stop according to the invention is thus used to reliably shield the intermediate space between the tube end and the optical three passage from light. Dirt is also prevented from entering. To some extent, it is also possible by using the stop to bridge differently sized distances between the open tube end of the tubular body and the optical through passage of the device housing by them being arranged at different depths in the hollow roll. In a particular embodiment, the surface element is rectangular. Optionally, it can then have outside edges of different lengths. By turning it through 90 degrees, the stop can then roll in two directions, resulting in two different lengths of the hollow roll for different distances between the open tube end of the tubular body and the optical through passage of the attachment device.

Provision is optionally made for the tubular body to be part of an aiming apparatus housing, in particular of a telescopic sight housing or a reflector sight housing. The stop can thus be used to effectively use telescopic sights that must be handled with great sensitivity. without the need for expensive molded parts made from rubber. According to a more detailed configuration, the first open tube end forms an eyepiece housing or an objective housing.

Provision is furthermore made in a specific embodiment for the attachment device to contain an optoelectronic unit, with which optical rays from the optical unit are visualized or digitally processed or data, information or graphics are optically injected into the beam path. Such devices can then be temporarily or optionally combined with the telescopic sight, and the optoelectronic unit supports or monitors for example the shooter. In this way, the optoelectronic unit can have, for example, a display, optical fibres, light-emitting means, residual light amplifiers or an overlay apparatus.

Further features, details and advantages of the invention emerge from the wording of the claims and from the following description of exemplary embodiments on the basis of the drawings. In the drawings:

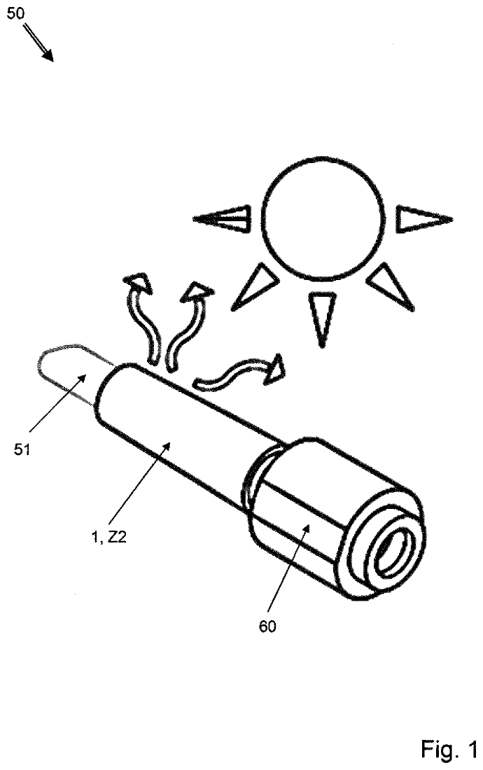

FIG. 1 shows an optical apparatus having a flexible stop;

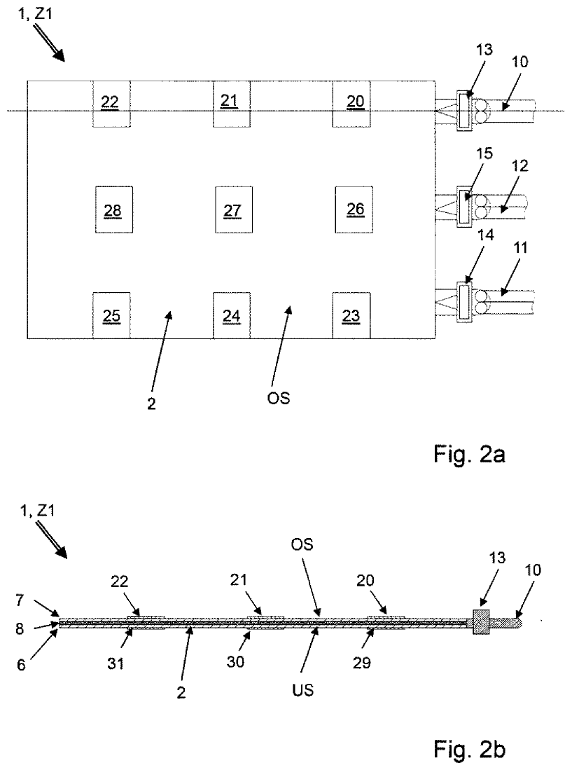

FIG. 2a shows a plan view of a flexible stop in a first state;

FIG. 2b shows a longitudinal section through the stop according to FIG. 2a;

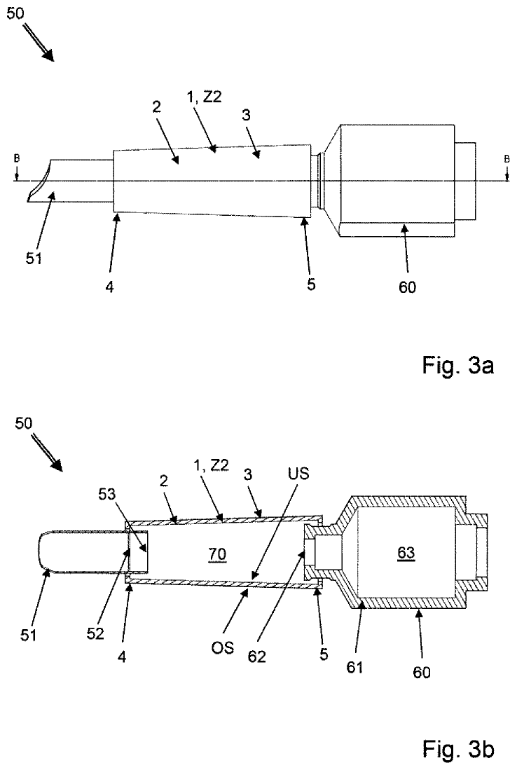

FIG. 3a shows a side view of the optical apparatus according to FIG. 1;

FIG. 3b shows a longitudinal section through the optical apparatus according to FIG. 3a;

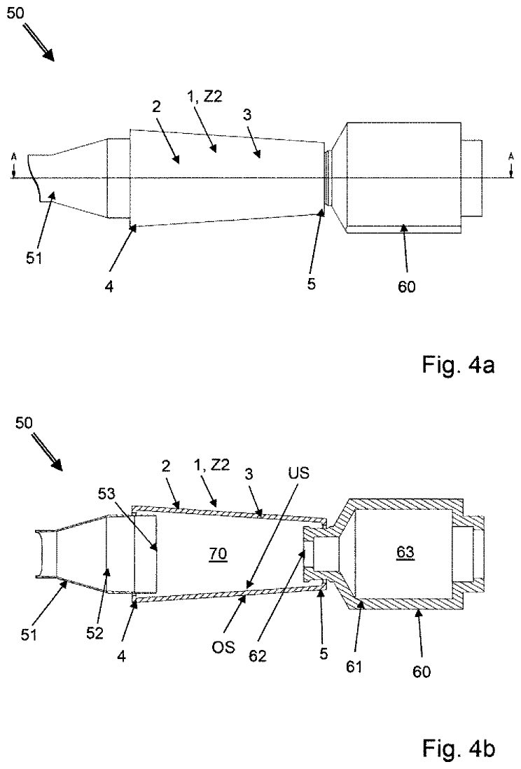

FIG. 4a shows a side view of a further optical apparatus;

FIG. 4b shows a longitudinal section through the optical apparatus according to FIG. 4a;

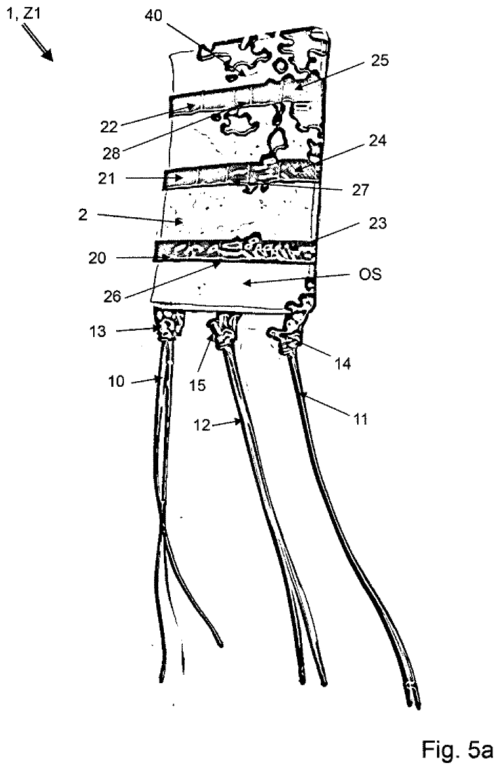

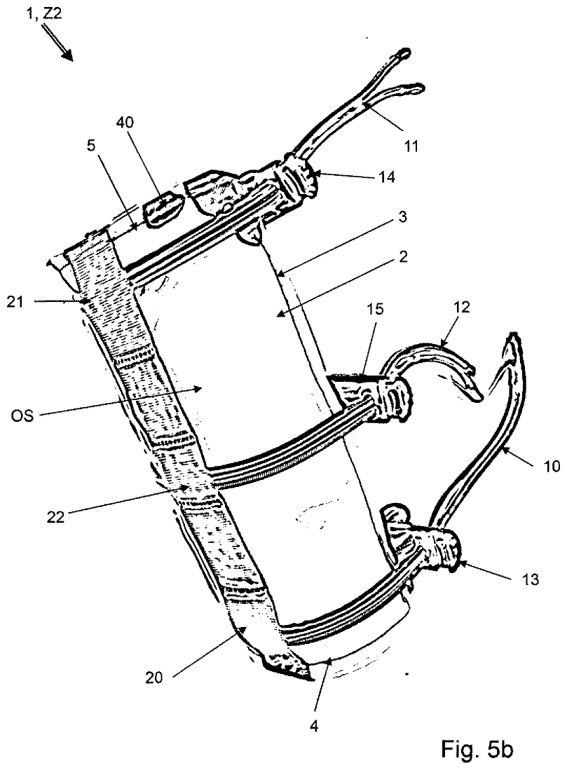

FIG. 5a shows a schematic diagram of a flexible stop in the first state; and

FIG. 5b shows a schematic diagram of the flexible stop according to FIG. 5a in the second state.

FIG. 1 shows an optical apparatus 50 having a flexible stop 1. The flexible stop 1 is here located between a tubular body 51 and an attachment device 60. The stop has been rolled or wound into a hollow roll 3 and thus forms an optical tunnel between the tubular body 51 and the attachment device 60.

FIGS. 2a and 2b are initially used to describe a possible more detailed configuration of such a flexible stop 1. The flexible stop 1 for an optical apparatus 50 according to FIG. 1 at least substantially consists of a flexible surface element 2 which, in a first state Z1, has a flat and planar shape and, in a second state Z2, is rolled or wound into a hollow roll 3, and at least two tensioning cords 10, 11, 12. In the present case, there are in particular three such tensioning cords 10, 11, 12 made from rubber cords, which in the second state Z2 are guided around the hollow roll 3 and then hold the hollow roll 3 in the rolled or wound shape. FIGS. 1, 3a, 3b, 4a, 4b and 5b each show the second state Z2, and FIGS. 2a, 2b and 5a show the first state Z1.

According to FIGS. 2a and 2b, at least two cord tunnels, here in particular exactly three cord tunnels, 20, 21, 22, 23, 24, 25, 26, 27, 28 per tensioning cord 10, 11, 12 are arranged on an upper side OS of the surface element 2. These cord tunnels 20, 21, 22, 23, 24, 25, 26, 27, 28 are formed in each case by sewn-on tabs. In each case one clamp 13, 14, 15 per tensioning cord 11, 12, 13 is fixed on a longitudinal side of the surface element 2.

The surface element 2 is opaque and has, as is clear from FIG. 5b, three layers, specifically a first layer 6 made of a textile fabric, a second layer 7 made of a textile fabric, and a stabilization layer 8 between the first and the second layer 6, 7, made of a bendable plate material or film material. The stabilization layer 8 can in particular be a flexible plastics element or insert.

As can furthermore be seen in FIG. 2b, a lower side US can be configured in a manner similar to the upper side OS of the flexible surface element 2 so that it is possible to use the upper side OS or the lower side US as the outer side of the hollow roll 3. To this end, cord tunnels in the form of tabs or straps are also arranged on the lower side US for this purpose. The upper side OS and the lower side US preferably have different camouflage patterns 40 and/or surface structures, in particular to optimize camouflage in different environments.

Such a flexible stop 1 according to FIGS. 2a and 2b can be brought into the second state Z2, as is illustrated in FIGS. 1, 3a, 3b, 4a, 4b 5b, by being rolled or wound. FIG. 3a here shows a side view of the optical apparatus according to FIG. 1, and FIG. 3b shows a longitudinal section through the optical apparatus according to FIG. 3a.

For this purpose, the tensioning cords 10, 11, 12 are guided in each case through at least two of the cord tunnels 20, 21, 22, 23, 24, 25, 26, 27, 28 and around the roll 3. The tensioning cords 10, 11, 12 are fixed by the first ends in each case in the region of the clamps 13, 14, 15, and they are secured and kept tensioned by the second ends with the clamps 13, 14, 15. As is evident from the positioning of the cord tunnels 20, 21, 22, 23, 24, 25, 26, 27, 28 in FIG. 2a, at least one of the tensioning cords 10 is then guided around the hollow roll 3 in the region of a first end 4 of the hollow roll 3, and a further one of the tensioning cords 11 is guided around the hollow roll 3 in the region of a second end 5 of the hollow roll 3. The third tensioning cord 13 is arranged centrally between the ends 4, 5.

According to FIGS. 3a, 3b, the optical apparatus 50 has a tubular body 51 containing an optical unit 52 and having a first open tube end 53. In addition, the optical apparatus 50 has an attachment device 60 having a device housing 61 with an optical through passage 62, in which an optoelectronic unit 63 is arranged. The flexible stop 1 has been brought into the second state Z2, wherein the flexible stop 1 is rolled or wound around the open tube end 53 of the tubular body 51 and the optical through passage 62 of the device housing 61. The surface element 2 is kept in the shape of a tube with the tensioning cords 10, 11, 12 and in this way forms an optical tunnel 70 between the open tube end 53 of the tubular body 51 and the optical through passage 62 of the device housing 61. The tubular body 51 is part of a telescopic sight housing, and the first open tube end 53 forms an eyepiece housing or an objective housing.

With the optoelectronic unit 63, optical rays from the optical unit 52 can be visualized or digitally processed, by way of example. data, information or graphics can be injected optically into the beam path, or night vision technology can be used.

The optical apparatus 50 according to FIGS. 4a, 4b differs from that according to FIGS. 3a, 3b only in that, in the latter case, the tubular end 53 has an outer diameter that is slightly smaller than the diameter of the device housing 61 in the region of the optical through passage 62. This results in a hollow roll 3 of the surface element 2, which is in the shape of a cone frustum and tapers slightly starting from the attachment device 60 in the direction of the tubular body 51. By contrast, the diameter of the tubular body 51 in the region of the first tube end 53 is significantly larger than the diameter of the device housing 61 in the region of the optical through passage 62. This also results in a hollow roll 3 of the surface element 2, which is in the shape of a cone frustum, but widens significantly starting from the attachment device 60 in the direction of the tubular body 51.

FIGS. 5a and 5b once again show perspective views of a flexible stop 1 in the first and second states Z1, Z2. The reference signs and explanations relating to FIGS. 2a, 2b here also apply, which is why reference is basically made to that part of the description. Different from the configuration of FIGS. 2a, 2b, the cord tunnels 20, 21, 22, 23, 24, 25, 26, 27, 28 according to FIGS. 5a, 5b are formed by straps, which are fixed in sections on the surface element 2 and thus in each case form a plurality of the cord tunnels 20, 21, 22, 23, 24, 25, 26, 27, 28.

The invention is not restricted to one of the embodiments described above, but rather may be modified in a variety of ways.

All the features and advantages that emerge from the claims, from the description and from the drawing, including structural details, spatial arrangements and method steps, may be essential to the invention both individually and in a wide variety of combinations.

### LIST OF REFERENCE SIGNS

1 flexible stop
2 flexible surface element
3 hollow roll
4 first end
5 second end
6 first layer
7 second layer
8 stabilization layer
10 tensioning cord
11 tensioning cord
12 tensioning cord
13 clamp
14 clamp
15 clamp
20 cord tunnel
21 cord tunnel
22 cord tunnel
23 cord tunnel
24 cord tunnel
25 cord tunnel
26 cord tunnel
27 cord tunnel
28 cord tunnel
29 cord tunnel
30 cord tunnel
31 cord tunnel
40 camouflage pattern
50 optical apparatus
51 tubular body
52 optical unit
53 first open tube end
60 attachment device
61 device housing
62 optical through passage
63 optoelectronic unit
70 optics tunnel
OS upper side
US lower side
Z1 first state
Z2 second state

1. A flexible stop (1) for optical apparatuses (50), having a flexible surface element (2) which, in a first state (Z1), has a flat and planar shape and, in a second state (Z2), is rolled or wound into a hollow roll (3), having at least two tensioning cords (10, 11, 12) which, in the second state (Z2), are guided around the hollow roll (3) and hold the hollow roll (3) in the rolled or wound shape.

2. The flexible stop (1) as claimed in claim 1, wherein the tensioning cords (10, 11, 12) are guided in the second state (Z2) in each case through at least two cord tunnels (20, 21, 22, 23, 24, 25, 26, 27, 28), which are arranged or formed on the surface element (2).

3. The flexible stop (1) as claimed in claim 1, wherein the cord tunnels (20, 21, 22, 23, 24, 25, 26, 27, 28) are formed by sewn-on tabs or straps.

4. The flexible stop (1) as claimed in claim 1, wherein the tensioning cords (10, 11, 12) are secured in the second state (Z2) with in each case one tensioning element or a clamp (13, 14, 15).

5. The flexible stop (1) as claimed in claim 4, wherein the tensioning elements or the clamps (13, 14, 15) are fixed in each case at the flexible surface element (2), preferably at its periphery.

6. The flexible stop (1) as claimed in claim 1, wherein at least one of the tensioning cords (10, 11, 12) is guided around the hollow roll (3) in the region of a first end (4) of the hollow roll (3) and a further one of the tensioning cords (10, 11, 12) is guided around the hollow roll (3) in the region of a second end (5) of the hollow roll (3).

7. The flexible stop (1) as claimed in claim 1, wherein the tensioning cords (10, 11, 12) are rubber cords.

8. The flexible stop (1) as claimed in claim 1, wherein the flexible surface element (2) has at least one first layer (6) made of a textile fabric.

9. The flexible stop (1) as claimed in claim 8, wherein the flexible surface element (2) has at least one second layer (7) made of a textile fabric.

10. The flexible stop (1) as claimed in claim 1, wherein the flexible surface element (2) has at least one stabilization layer (8) made of a bendable plate material or film material.

11. The flexible stop (1) as claimed in claim 8, wherein the stabilization layer (8) is arranged between the first and second layers (6, 7).

12. The flexible stop (1) as claimed in claim 1, wherein an upper side (OS) and a lower side (US) of the flexible surface element (2) are configured in the same way so that it is possible to use the upper side (OS) or the lower side (US) as the outer side of the hollow roll (3).

13. The flexible stop (1) as claimed in claim 1, wherein the upper side (OS) and the lower side (US) have different camouflage patterns (40) and/or surface structures.

14. The flexible stop (1) as claimed in claim 1, wherein the flexible surface element (2) is opaque.

15. An optical apparatus (50) having
a tubular body (51) containing an optical unit (52) having a first open tube end (53),
an attachment device (60) having a device housing (61), wherein an optical through passage (62) of the device housing (61) is arranged in front of the open tube end (53), and
a flexible stop (1) as claimed in claim 1 in the second state (Z2), wherein the flexible stop (1) is rolled or wound around the open tube end (53) of the tubular body (51) and the optical through passage (62) of the device housing (61), held in the shape of a tube with the tensioning cords (10, 11, 12), and thus forms an optical tunnel (70) between the open tube end (53) of the tubular body (51) and the optical through passage (62) of the device housing (61).

16. The optical apparatus (50) as claimed in claim 15, wherein the tubular body (51) is part of an aiming apparatus housing, in particular of a telescopic sight housing or a reflector sight housing.

17. The optical apparatus (50) as claimed in claim 15, wherein the first open tube end (53) forms an eyepiece housing or an objective housing.

18. The optical apparatus (50) as claimed in claim 15, wherein the attachment device (60) contains an optoelectronic unit (63), with which optical rays from the optical unit (52) are visualized or digitally processed or data, information or graphics are optically injected into the beam path.
